(19) United States
(12) Patent Application Publication
(10) Pub. No.: US 2004/0225480 A1
(43) Pub. Date: Nov. 11, 2004

(54) Method for analysis and design of a security system

(76) Inventor: Dale Dunham, Birmingham, AL (US)

Correspondence Address: BRADLEY ARANT ROSE & WHITE LLP, 200 CLINTON AVE. WEST, SUITE 900, HUNTSVILLE, AL, 35801, US

(21) Appl. No.: 10/430,494

(22) Filed: May 6, 2003

(51) Int. Cl. G06F 17/50; G06G 7/48

(52) U.S. Cl. 703/1; 703/6

(57) ABSTRACT

The invention is a method for analyzing the capabilities of a security system. The invention includes creating a computerized depiction of a secured area. The existing security measures, if any, are included in the depiction. A depiction of the areas covered by the security measures is also generated. The depiction of the coverage shows any gaps in the existing security system.

### BACKGROUND OF INVENTION

1. Field of the Invention

The invention relates generally to computer software. More specifically, the invention relates to computer software that implements a method for analyzing and designing a security system.

2. Background Art

Security needs are an ever increasing concern for high-risk facilities such as airports, military bases, government offices, seaports, utilities, petrochemical plants, etc. Typical security measures involve the use of perimeter security devices with controlled access points, roving/stationary guards, and automated monitoring devices. These measures may be used alone or in combination with each other.

When security measures are installed, they are typically laid out in a trial and error manner. Problem areas such as dead spots where potential dangers cannot be detected are not found until after the measures are installed if they are found at all. Also, when a security system is upgraded with new equipment or manpower, integrating the old system with the additional measures can be daunting. It would require a great deal of coordination to insure that no new gaps in security coverage are created by the upgrade. Consequently, a method of analyzing and designing an integrated security system is needed.

### SUMMARY OF INVENTION

In some aspects, the invention relates to a method for analyzing a security system, comprising: creating a surface depiction of a secured area covered by the security system; placing existing security measures on the surface depiction; and generating a surveillance surface on the surface depiction, where the surveillance surface shows the portion of the secured area that is under surveillance by the security measures.

In other aspects, the invention relates to a method for analyzing a security system, comprising: step for depicting a secured area covered by the security system; step for depicting the security measures of the security system; and step for showing the coverage of secured area by the security measures.

In other aspects, the invention relates to a method for designing a security system, comprising: creating a surface depiction of an area to be secured; placing a security measure on the surface depiction; generating a surveillance surface on the surface depiction, where the surveillance surface shows the portion of the area that is under surveillance by the security measure; and re-locating the security measure or placing additional security measures on the surface depiction to cover gaps in the surveillance surface.

In other aspects, the invention relates to a method for designing a security system, comprising: step for depicting an area to be secured by the security system; step for depicting the placement of security measures of the security system; step for showing surveillance coverage of the area to be secured by the security measures; and step for depicting the adjustment or addition of security measures to cover gaps in surveillance coverage of the area to be secured.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 is a flow chart that shows a method of analyzing and designing a security system in accordance with one embodiment of the present invention.

FIG. 2 is a flow chart that shows a method of generating risk/surveillance analysis and design of a security system in accordance with one embodiment of the present invention.

FIG. 3 is a flow chart that shows a method of creating a 3 dimensional surface depiction of a secured area in accordance with one embodiment of the present invention.

FIG. 4 shows an exploded view of a topographic surface depiction of a surveyed area in accordance with one embodiment of the present invention.

FIG. 5 shows a topographic view of a surveillance surface in accordance with one embodiment of the present invention.

FIG. 6a shows a three dimensional view of the surveillance surface shown in FIG. 5.

FIG. 6b shows a 3 dimensional view of a surveillance surface produced by analyzing a combination of human and mechanical surveillance techniques for a critical area in accordance with one embodiment of the present invention.

FIG. 7 shows two line-of-sight calculations for a 3 dimensional surface in accordance with one embodiment of the present invention.

FIG. 8 shows surveillance surface calculations for a stationary sentry in accordance with one embodiment of the present invention.

FIG. 9 shows an overhead view of a sentry route for a surveillance surface in accordance with one embodiment of the present invention.

FIG. 10 shows an effective area calculation along the sentry route shown in FIG. 9.

FIG. 11 shows a surveillance surface of the sentry route shown in FIG. 10.

FIG. 12 shows an effective area calculation of a sensor for a surveillance surface in accordance with one embodiment of the present invention.

FIG. 13 shows the addition of the effective area calculated in FIG. 12 to a surveillance surface.

FIG. 14 shows an effective area calculation of an additional sensor for a surveillance surface in accordance with one embodiment of the present invention.

FIG. 15 shows a diagram of critical infrastructure and associated threat areas for a risk surface in accordance with one embodiment of the present invention.

FIG. 16 shows a method of creating threat areas for a risk surface based on the kill envelope of specific weapons systems in accordance with an alternative embodiment of the present invention.

FIG. 17 shows risk surface created in accordance with one embodiment of the present invention.

FIG. 18 shows a diagram of a 3 dimensional surface of a harbor with a security system in accordance with one embodiment of the present invention.

FIG. 19 shows a sentry route for the harbor shown in FIG. 17.

FIG. 20 shows effective area calculations along the sentry route for a surveillance surface of the harbor shown in FIG. 18.

FIG. 21 shows a surveillance surface along the sentry route of the harbor shown in FIG. 18.

FIG. 22 shows an effective area calculation for an additional sensor for the surveillance surface of the harbor shown in FIG. 21.

FIG. 23 shows an updated version of the surveillance surface of the harbor shown in FIG. 21.

FIG. 24 shows a flight line sentry route in an airport to be secured with a security system in accordance with one embodiment of the present invention.

FIG. 25 shows an effective area calculation along the sentry route shown in FIG. 24.

FIG. 26 shows a sentry footprint for the surveillance surface of the airport shown in FIG. 25.

FIG. 27 shows effective area calculations for additional sensors for the airport shown in FIG. 26.

FIG. 28 shows effective area calculations for additional sensors for the airport shown in FIG. 27.

FIG. 29 shows the surveillance surface resulting from the combination of sentries and sensors.

FIG. 30 shows a three dimensional view of the surveillance surface shown in FIG. 27.

FIG. 31 displays the risk and surveillance surfaces simultaneously.

FIG. 32 displays the security surface created by decreasing the risk surface by the amount of the surveillance surface.

FIG. 33 is a cross section of the security surface shown in FIG. 32.

### DETAILED DESCRIPTION

A method of analyzing and designing an integrated security system with computer software has been developed. The software that implements this method is intended to be used with a computer to assist and facilitate the analysis and design of an integrated security system for a specified area. An integrated security system is a system that may include combinations of different types of surveillance and detection devices such as sentries and manned or unmanned sensors. The mix of sentries and sensors may vary according to needs, conditions, budget, threat level to the area to be secured, etc. In some cases, manned sensors or sentries may not be practical which necessitates a total reliance on unmanned sensors. In other cases, sentries may be used only at certain times (i.e., a controlled access gate that is open only during business hours) that may necessitate the use of unmanned sensors to replace the sentries during their absence.

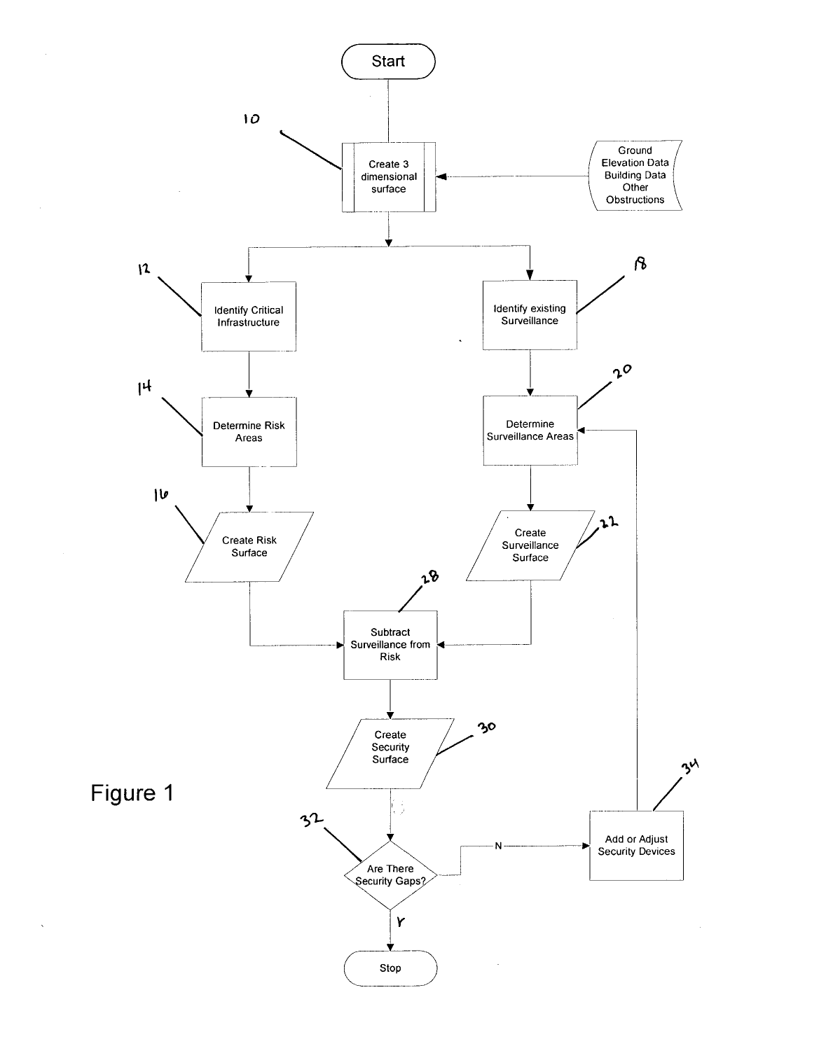

FIG. 1 shows a flow chart that shows a method of analyzing and designing a security system in accordance with one embodiment of the present invention. The first step in the method involves the creation of a 3 dimensional surface depiction of the area to be secured 10. This area is referred to as a critical area which may include surface structures, airspace and underground features such as water sources. A 3 dimensional surface depicts a digitized model of the topography, natural environment, built-up environment, and other features that may affect the effectiveness of security measures. Next, critical infrastructure is identified including critical facilities such as communications centers or storage areas for flammable or explosive materials 12. These type facilities may require special attention such as additional security perimeters, buffer zones, etc. Such requirements should be noted so that extra surveillance can be provided if needed.

Once each infrastructure asset is digitized, areas are characterized based on the level of risk they represent 14. Risk areas are determined based on potential threats to each critical area. This may be based on the role of a critical area or calculated based on the weapons likely to be used against the critical area. Examples of risks include: intruders; bombs; snipers; etc. Many of these risks may be a threat located outside the boundaries of the secured area. For example, a sniper could be located outside a security fence of a secured area but could still be a threat by firing on targets inside the fence perimeter. Likewise, a car bomb could be placed outside the fence but could be detonated and damage buildings within the perimeter. Consequently, a risk area should include an expanded area that includes all locations that are within range of critical facilities without regard to the actual boundaries of the secured area.

A risk surface for the area is created by combining the risk areas to achieve a comparative risk value. A risk surface is a continuous measurement of the perceived security risk of the area to be secured and its environs. The actual risk surface itself may be an overlay placed on the surface depiction of the secured area. It should cover all areas that could contain a potential threat whether inside the secured area or not. These areas are combined to create a risk surface, which is a continuous measurement of risk throughout the secure area 16.

A surveillance surface 22 is created from data that includes the characteristics and locations of every sensor and/or sentry that is present in the secured area 18. The surveillance surface depicts the characteristics and locations of the each surveillance measure and determines what areas are presently covered. It is a continuous measurement of surveillance throughout the secure area.

In creating a security surface, the security environment is inventoried to identify any existing sensors (whether manned or unmanned) and to identify any existing sentries or patrol routes 18. If any sentries or sensors are present, the characteristics of each are entered respectively 20. Additionally, the individual locations of each sentry (with patrol route if applicable) and/or sensor are plotted on the surface depiction. Categories of sentries may include: stationary; roving (either on foot or by vehicle); whether or not surveillance equipment is carried; etc. Characteristics of the sentries may include: observation range, route, speed of movement, frequency of patrol, height of observation platform, weaponry, etc. The important feature is that the observation range of the sentry at each position occupied be determined. Categories of sensors may include: closed circuit television (CCTV); infrared (IR); ambient light amplification; magnetic; seismic; acoustic; motion; light barrier; radar; etc. Characteristics of sensors may include: detection range; manned/unmanned; effective area; height of sensor platform; etc. As with sentries, the important feature is that the observation range of the sensor be determined.

Determination of the observation range for either a sentry or a sensor should take into account the interaction of the characteristics of the sensor/sentry with environmental factors. Consideration should be given to surveillance capacity in 24-hour/day, 365-day/year environments. For example, the effects of environmental factors such as rain, fog, snow and darkness should be factored into the observation range of a sensor or sentry. Other examples of such environmental conditions may include: moonlight enhancement of night visibility; night visibility with enhancement by streetlights; IR observation capability through foliage; lack of foliage in fall/winter seasons; etc. The capacity of each type of surveillance measure available should be factored into each type of environmental condition that may be encountered when assigning an observation range. In fact, the observation range of certain types of sensors or sentries may be substantial under some conditions while it may be non-existent under other conditions. This information is used to analyze and design a security system that is effective in day and night and in all types of weather.

Subtracting the surveillance surface from the risk measurement 28 creates a security surface 30 that is used in making a risk/surveillance analysis. A security surface is an area representing the adequacy of security surveillance. The risk/surveillance analysis will identify the relative performance of the system as well as any gaps in security coverage for the entire secured area. The actual surveillance surface itself may be an overlay placed on the previously created overlay of the risk surface of the secured area. This allows the user to easily and quickly identify any gaps, “blind spots”, or other potential weaknesses in security coverage 32.

The result of the analysis is used to determine whether or not the present security system for the secured area is adequate 32. If the security system is deemed adequate, the present invention typically ends and does not design any additional security measures. However, if the present security system is not adequate, the design embodiment of the present invention is used. Specifically, sensors or sentries are placed/adjusted 34 on the surface depiction. Once again, for each additional measure, its respective characteristics, locations, and/or route are entered to update the surveillance surface 20 and 22.

In other embodiments, gaps in security coverage may be determined relative to the level of threat faced. For example, while security coverage may be present for a critical area, it may be determined that extra measures are required due to its specific nature. Also, the relative effectiveness of each measure may be used to indicate a gap in coverage. For example, sentries may not be as effective at night as an IR sensor. Also, a patrolling sentry is only present at a specific point intermittently. Consequently, a sentry may be designated as a gap in security coverage relative to other measures. The method of creating a risk/surveillance analysis should have enough flexibility to allow for customization based on the specific needs and threats to an area.

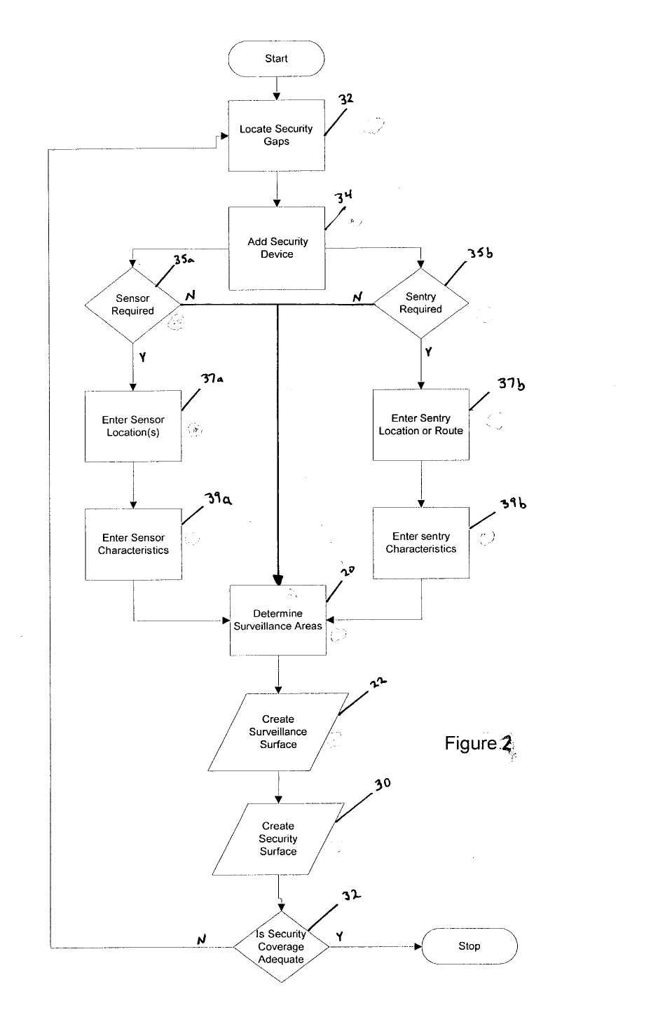

In an alternative embodiment, the present invention may be used to design a security system from scratch. In this embodiment shown in FIG. 2, no pre-existing sensors or sentries are present in the secured area. The invention proceeds to generate an initial 3 dimensional surface, a risk surface, and a surveillance surface and determine the security gaps 32. If sensors and/or sentries are required 35a and 35b, their placed on the 3 dimensional surface depiction with their respective locations 37a and 37b and characteristics 39a and 39b. The surveillance surface is updated 20 and 22. A new security surface is created 30 and it is analyzed for adequate security coverage 32. The process of adding sensors/sentries continues until a satisfactory design for an integrated security system is created.

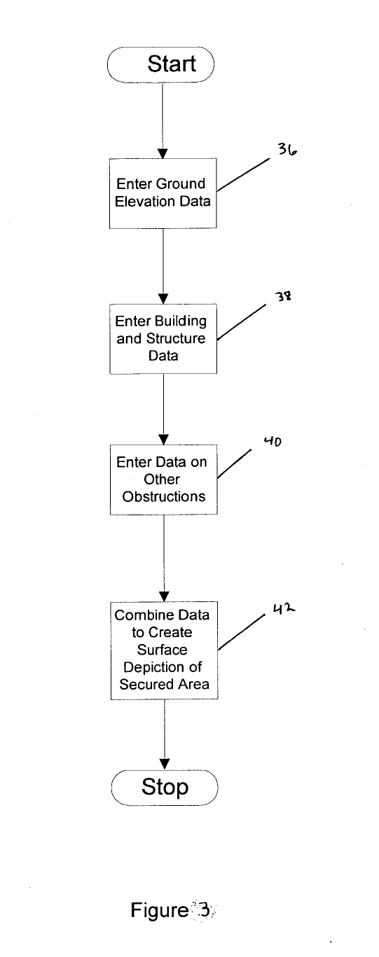

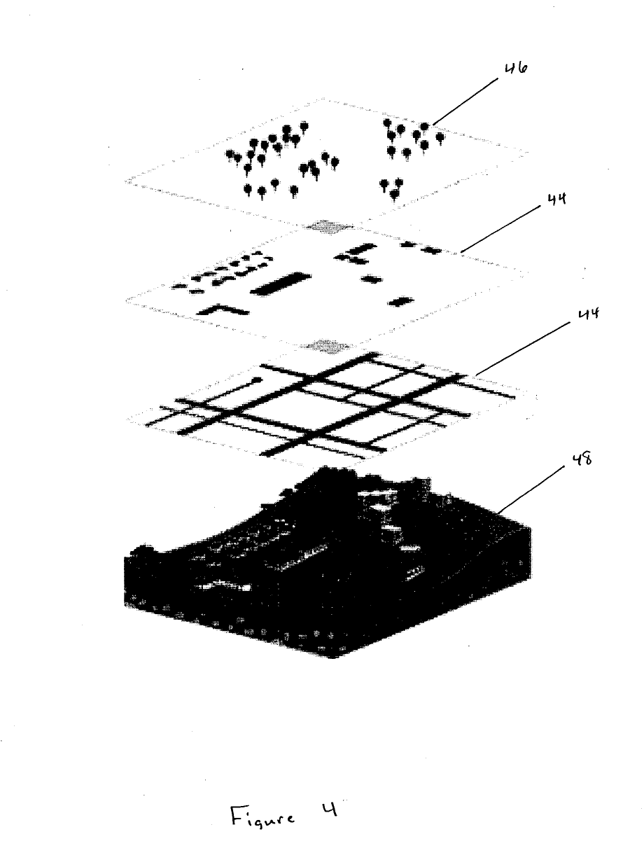

FIG. 3 is a flow chart that shows a method of creating a 3 dimensional surface depiction of a secured area 10. The secured area includes the actual physical premises to be secured and its surroundings that could hold a potential threat. In the first step, a complete survey with topographic elevation data is entered 36. The topographic data includes the entire designated area to be secured as well as its immediate surroundings. Next, data on buildings and other structures are added 38. This data is entered for not only buildings, but for structures such as roads, woods, ditches, bridges, overpasses, parking lots, etc. Next, data is entered for any obstructions or other points that be of interest to security personnel 40. Examples of such structures/obstructions include: walls, fences, traffic barriers, trash containers, manholes, streetlights, landscaping, etc. Such data entered for buildings, structures, obstructions includes: precise location; layout; height; size; condition; attendance; regularly scheduled activity; seasonal condition (i.e., lack of foliage in winter); etc. Finally, all of this data is combined to create an accurate topographic surface depiction of the area to be secured and its immediate surroundings 42. FIG. 4 shows an exploded view of a topographic surface depiction of a surveyed area. The data for buildings and structures 44 is overlaid on the topographic data 48 collected for the secured area. Finally, the data for the obstructions and other points of interest 46 is added to complete the surface depiction.

The data collection may be done with survey-grade Global Positioning System (GPS) equipment that is commercially available. Examples of such equipment include a Trimble Unit or other similar products manufactured by Motorola, Garmin, Magellan, etc. Typically, a survey team goes out to physically survey the site for topographic information. The team also inspects the area for other important data such as the condition of structures, attendance, regularly scheduled activity, etc. The data is enter into a surveying or map-making computer software package such as Arc Pad Application Builder, Arc GIS/3D Analysis, or other types of field data software tools that are available. The important feature is that the software package supports collection of all features that will affect line-of-sight from one point to another in the secured area.

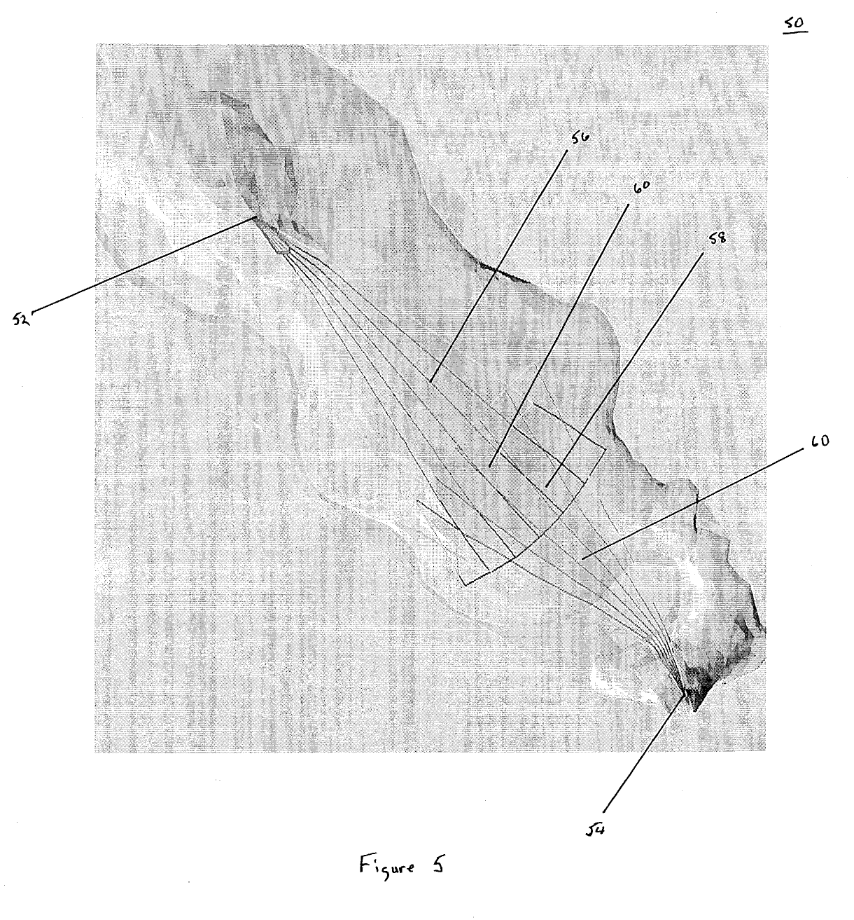

FIG. 5 shows a topographic view of a surveillance surface 50 that provides an example of the analysis method of one embodiment of the present invention. The surveillance surface 50 shows a three dimensional (3D) topographic depiction of a secured area. Two separate sensors 52 and 54 are located on two respective hilltops in the area. Each sensor is given an effective area 56 and 58 that it is oriented to monitor out to the extent of its respective observation range. The effective area is a 3 dimensional area where a security measure will be effective. It may correspond with the line-of-sight of the measure.

The line-of-sight from each sensor to each point within its effective area 56 and 58 is calculated. In this example, the line-of-sight of the sensors is indicated by sight lines drawn at periodic intervals across the effective areas 56 and 58. If the line-of-sight is blocked to a section of the effective area, a “blind spot” is created where the sensor can observe no activity. In this example, the blind spot 58 for the first sensor 52 is indicated by a change in color the line-of-sight lines of the effective area 56. In this example, the second sensor 54 covers the blind spot 58 of the first sensor 52 so that no lapse in surveillance coverage exists in the secured area. This example illustrates a key advantage of the present invention in that it identifies gaps in surveillance and allows the coordinated placement of additional security measures to cover those gaps. This results in an integrated, effective security system.

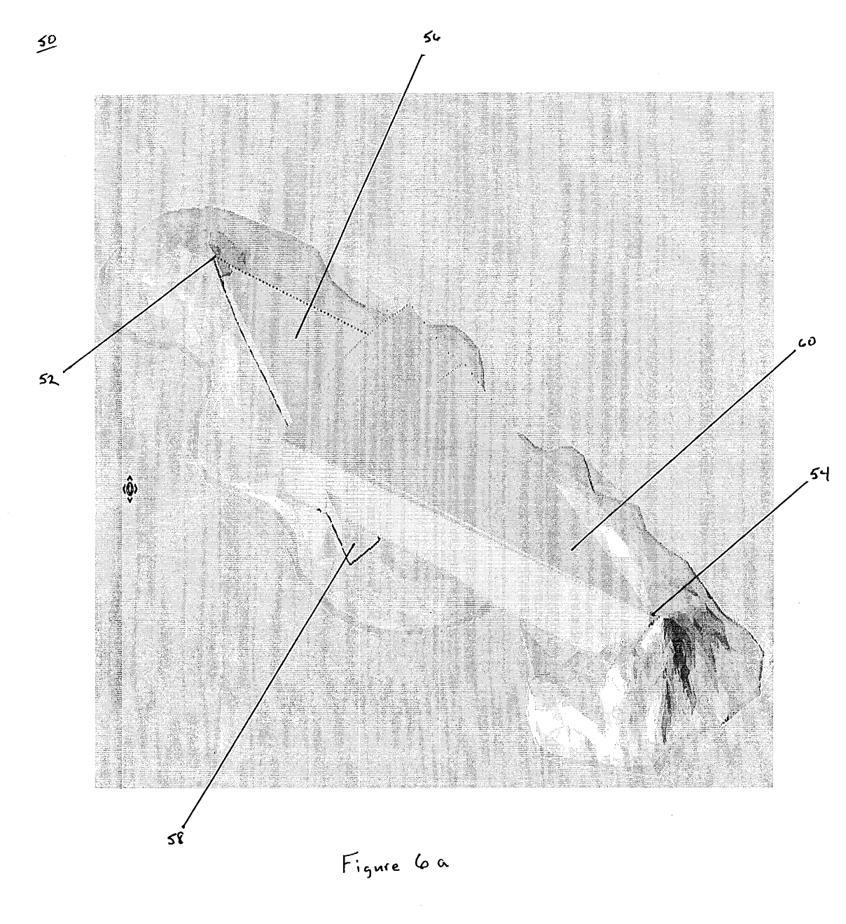

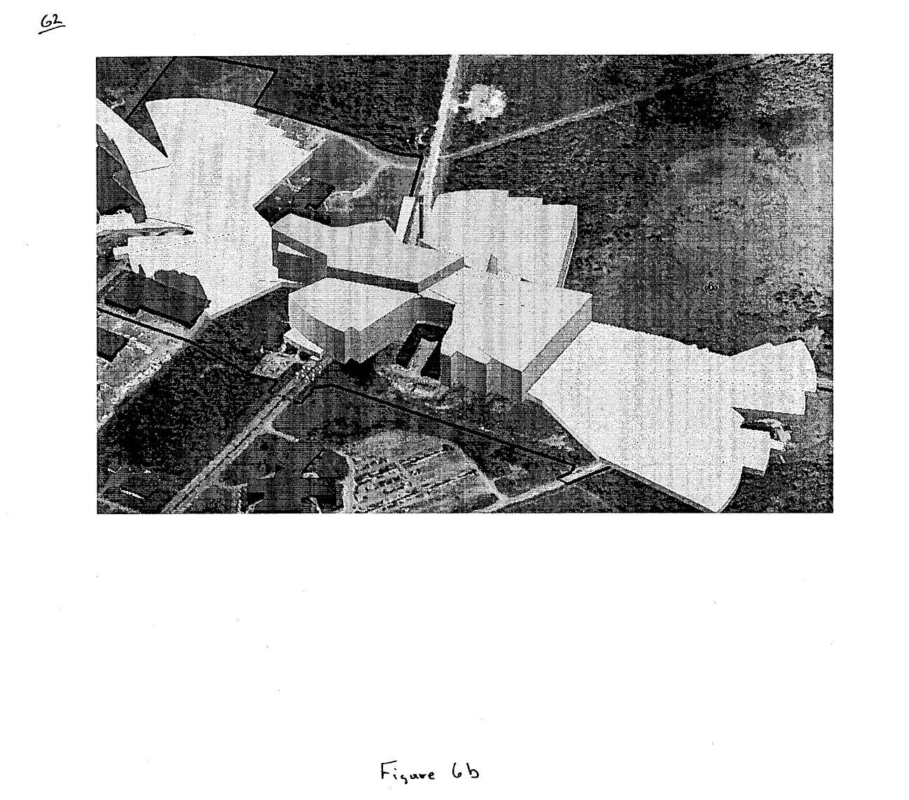

FIGS. 6a and 6b show an additional feature of the present invention that allows analysis of the relative effectiveness of the surveillance measures. FIG. 6a shows a 3D view of each effective area 56 and 60 previously described in FIG. 5. The 3D views show the effectiveness of each sensor relative to each other in all conditions. The views are 3D polygon shapes that conform to the respective effective areas. In these displays, the greater the height of the polygon, the more effective the surveillance. For example, the first sensor 52 may be a manned observation post that is occupied only during daylight. Consequently, the height of its effectiveness display is relatively low. In contrast, the second sensor may be an unmanned IR automated camera that is able to operate around the clock in daylight, darkness, and all weather conditions. It is represented by a display that is tall as compared to the display for the first sensor. FIG. 6b shows another example of what a 3D effectiveness display for a more complex security system would look like.

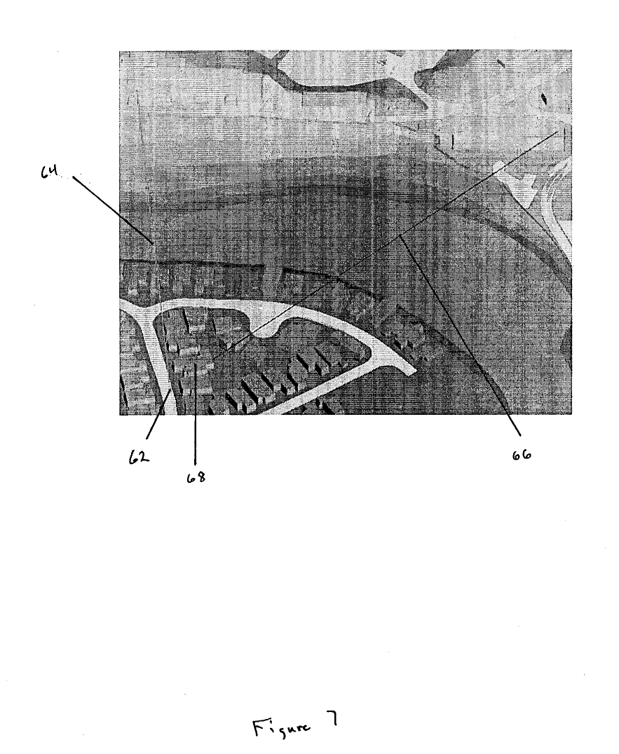

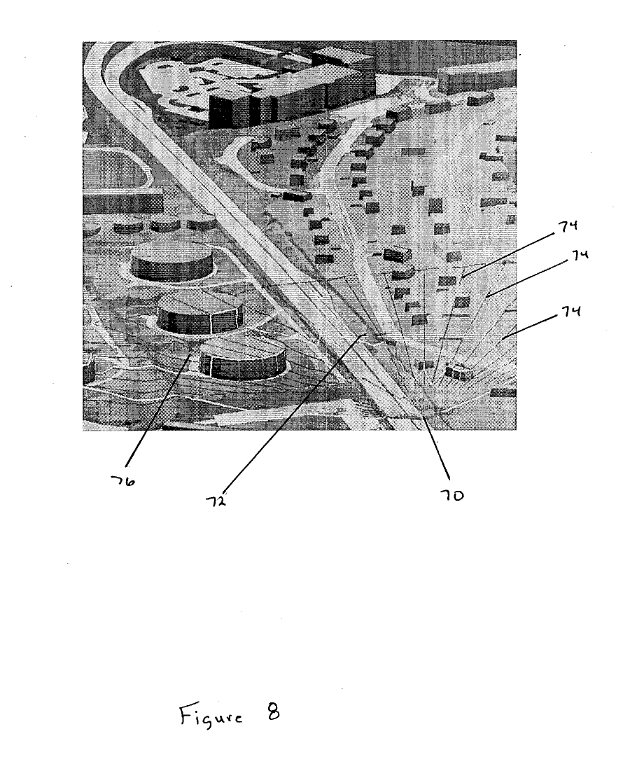

FIGS. 7 and 8 show examples of line-of-sight calculations in more complex secured areas. FIG. 7 shows examples of two separate line-of-sight calculations for a roving sentry in an urban area. The sentry 62 is located on a street in a built up area. The sentry's first line-of-sight 64 is down the street and across the river. The line-of-sight 64 is clear to the building on the hill across the river since nothing blocks the view. A clear line-of-sight may be indicated by color-coding the representative line (e.g., green). In contrast the sentry's second line-of-sight 66 is blocked by the elevation of buildings 68 on the street. A blocked line-of-sight may also be indicated by color-coding the representative line (e.g., red). FIG. 8 shows another example of line-of-sight calculations for an effective area of a sensor in an urban area. The sensor 70 is placed adjacent to a road. Its assigned effective area 72 extends forward in an approximately 150° angle of coverage. Multiple line-of-sight calculations 74 are made at periodic intervals across the effective area 72. As with the line-of-sight calculations previously described in FIG. 7, the lines may be colored coded to indicate a clear or blocked line-of-sight. Areas that are blocked from view of the sensor or “blind spots” 76 are indicated by color-coding the representative lines (e.g., red). Areas that are observed by the sensor are indicated by color-coding the representative lines in another color (e.g., green). In other examples, areas that are partially obscured such as by darkness, seasonal foliage, weather, etc. may be indicated by a different color-coding (e.g., yellow).

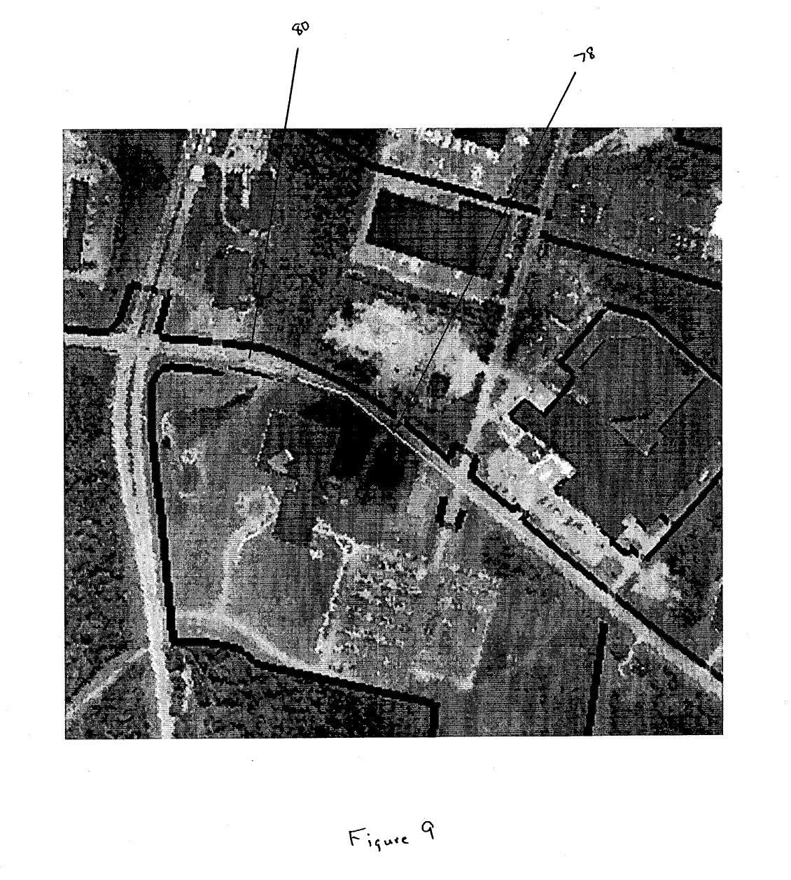

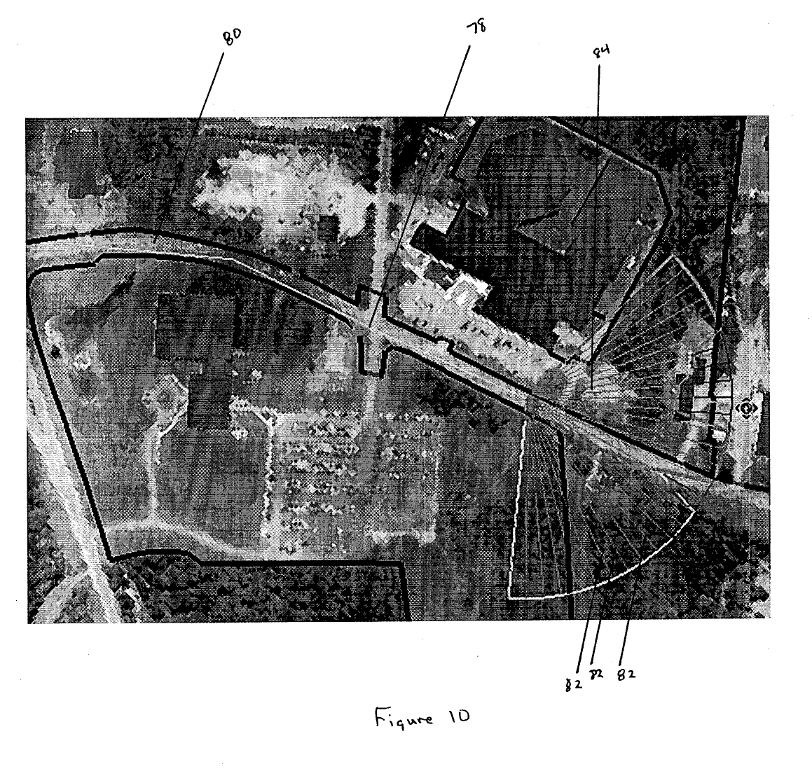

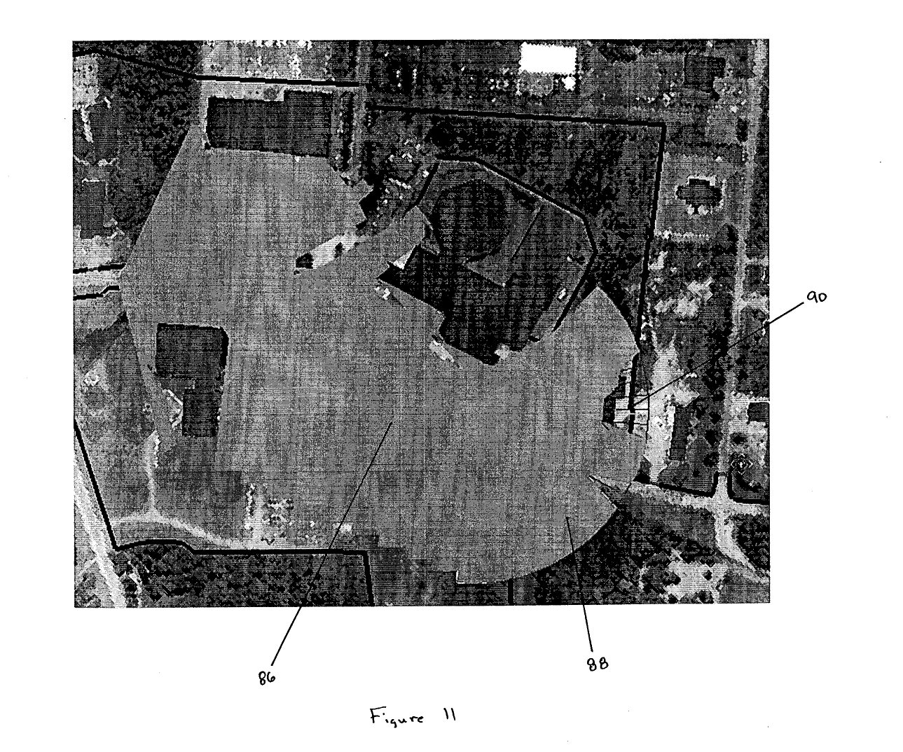

FIGS. 9-11 show an example of analysis of a surveillance surface for a mobile sentry. FIG. 9 shows an overhead view of a sentry patrol route 78 for a surveillance surface. First, the sentry patrol route 78 is entered on the surface depiction of the secured area. In this example, the route is along a road 80 that is to be patrolled. Next, as shown in FIG. 10, line-of-sight calculations 82 for an effective area 84 are made along the sentry route 78. Finally, as shown in FIG. 11, a surveillance surface 86 is generated after an effective area is calculated for each point along the sentry route. The effective areas are overlaid to determine the entire scope of surveillance along the route. The surveillance surface 86 shows areas that are visible 88 to the sentry as well as blind spots 90 that are blocked from view. This example illustrates a method of detailed analysis of the surveillance coverage of a sentry.

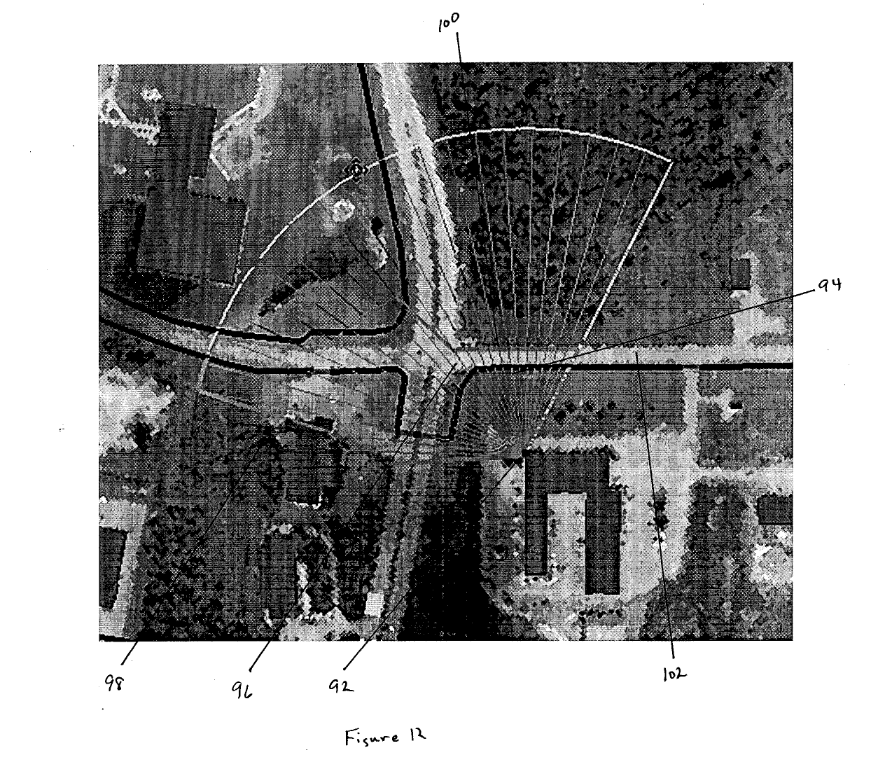

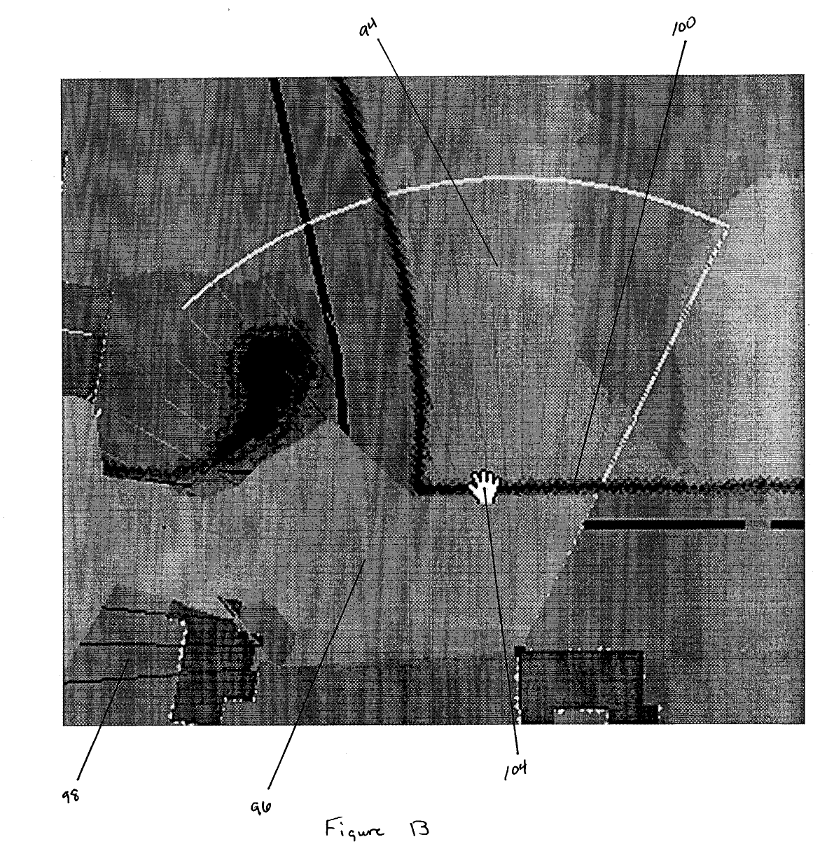

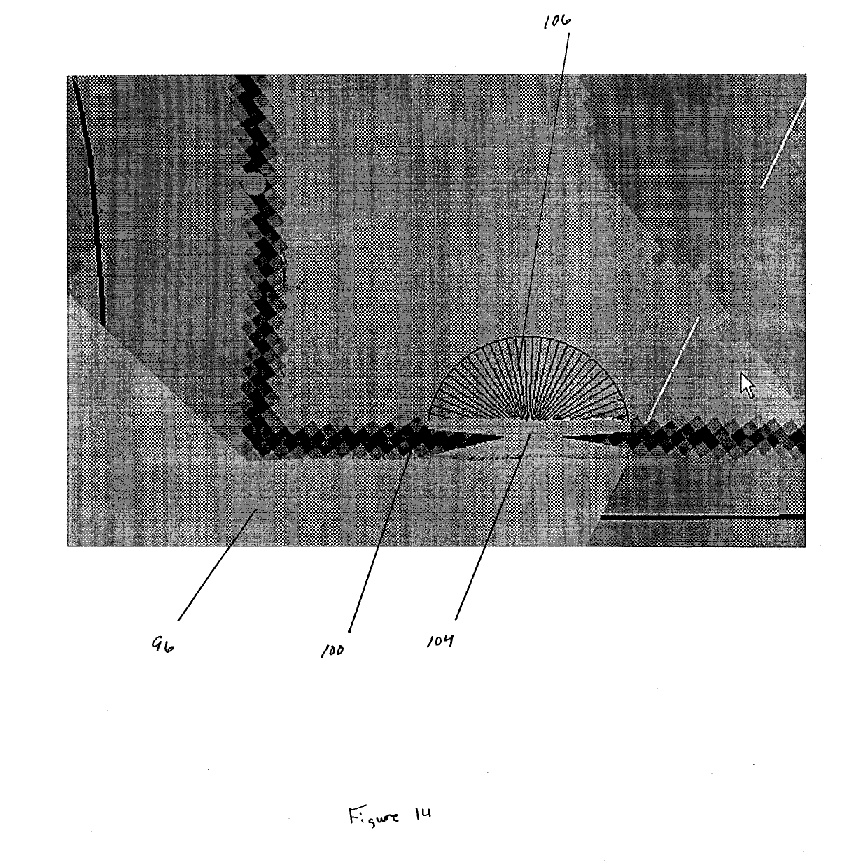

FIGS. 12-14 show an example of design of a surveillance surface with the placement of additional fixed sensors. FIG. 12 shows a fixed sensor 92 on the surface depiction of the secured area. An effective area 94 is calculated for the area covered by the sensor including areas with a clear line-of-sight 96 and blindspots 98. One blindspot that is shown in FIGS. 12 and 13 is a ditch 100 that runs parallel to the road 102 in front of the fixed sensor 92. An additional fixed sensor 104 is placed in the ditch 100, as shown in FIG. 13, in order to provide surveillance of the blindspot. As shown in FIG. 14, after the additional sensor 104 is placed, its effective area 106 is calculated and added to the surveillance surface of the area. This example illustrates a method of designing an integrated security system that provides complete surveillance coverage of the secured area.

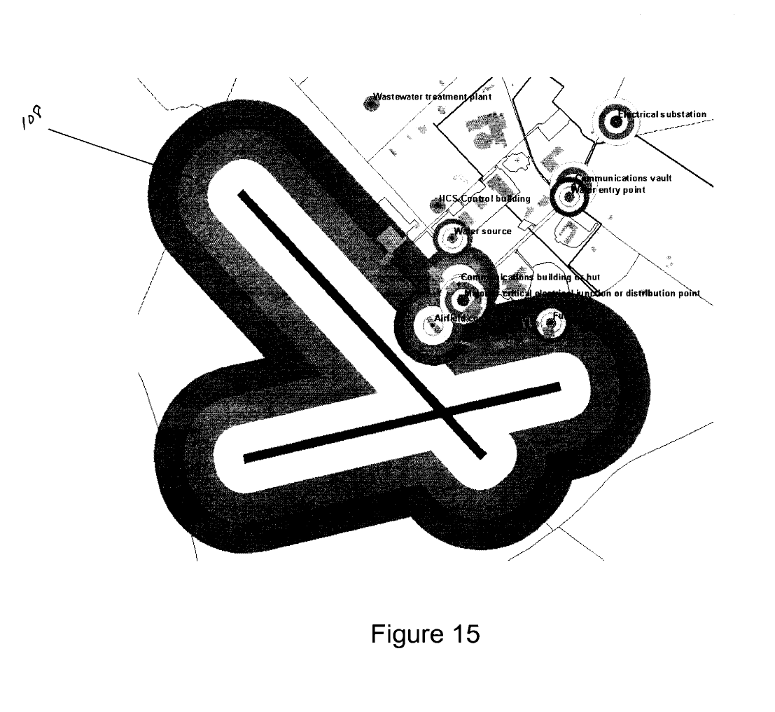

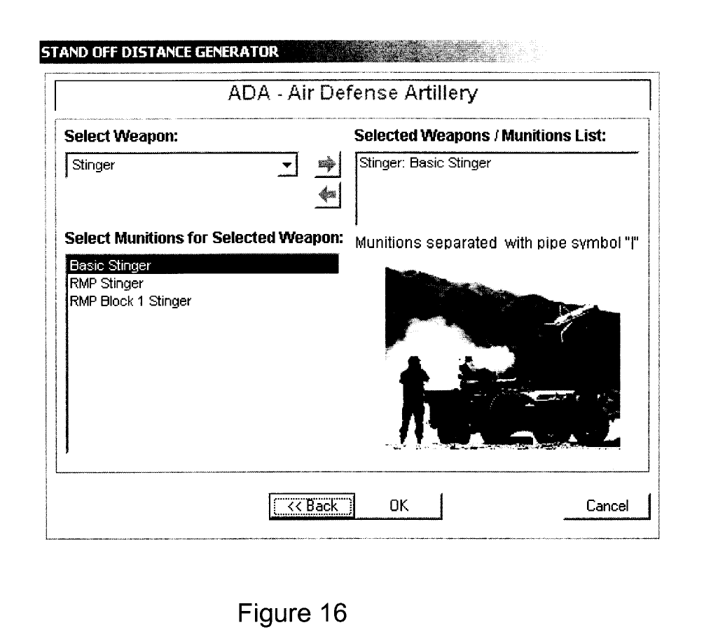

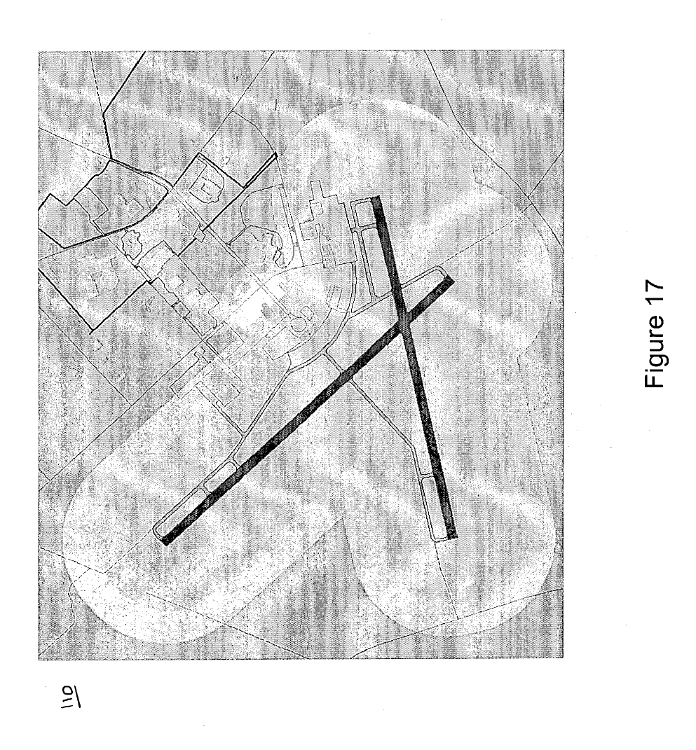

FIGS. 15-17 show examples of generating a risk surface for critical facilities on a surface depiction. In FIG. 15, stand off distances 108 have been defined based on the nature of the critical area. In this example, the critical area is an airfield and the identified threat is a man-portable, surface-to-air missile designed to shoot down an aircraft. The stand off distance 108 is necessary buffer zone around the airfield needed to ensure protection against the missile. As shown in FIG. 16 stand off distances may be determined based on the kill envelopes of specific weapon systems. In this example, the missile threat is Stinger shoulder-fired missile. Its effective ranges are defined in Army manual DA PAM 385-63. Kill envelopes typically depends on the weapon, ammunition, and firing conditions. Each of these parameters is either selected or entered by the user. Based on the input, stand off distances are automatically generated and added to the risk surface 110 as shown in FIG. 17.

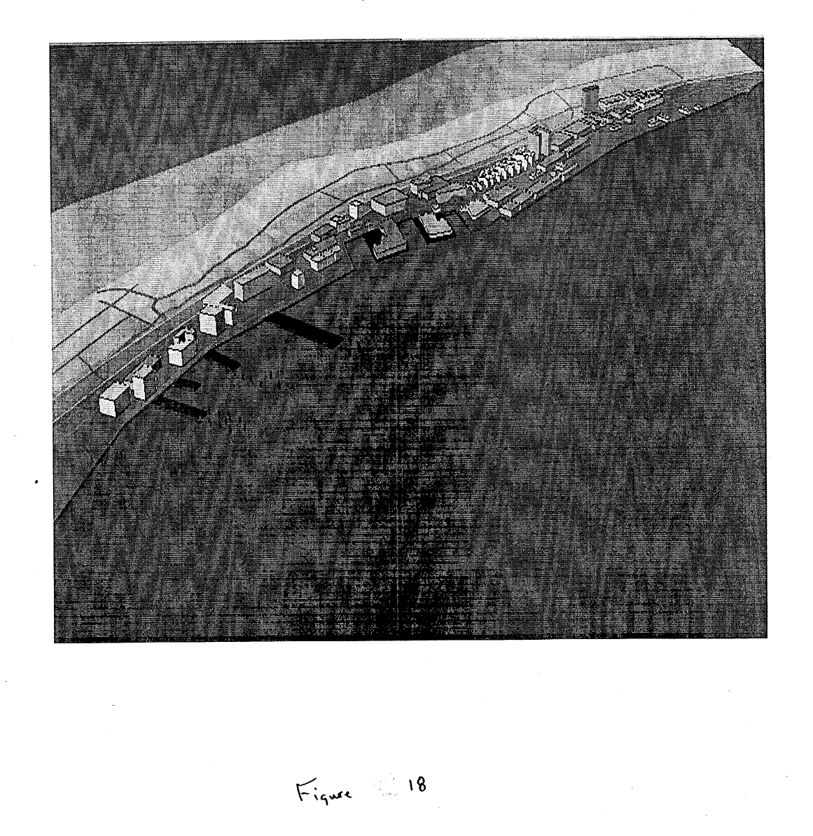

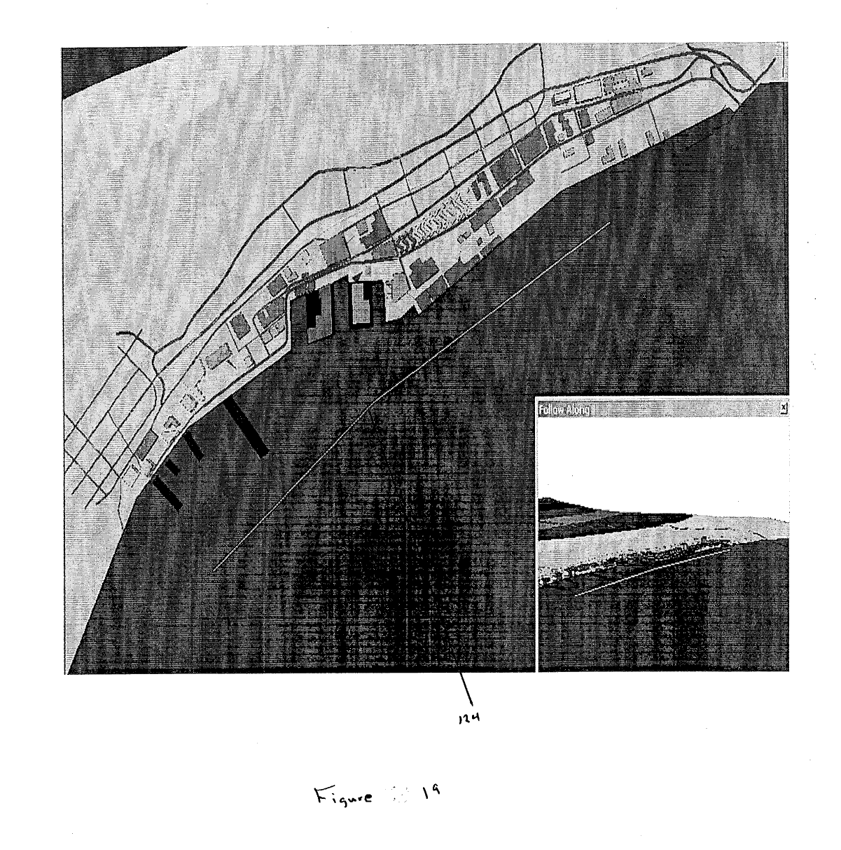

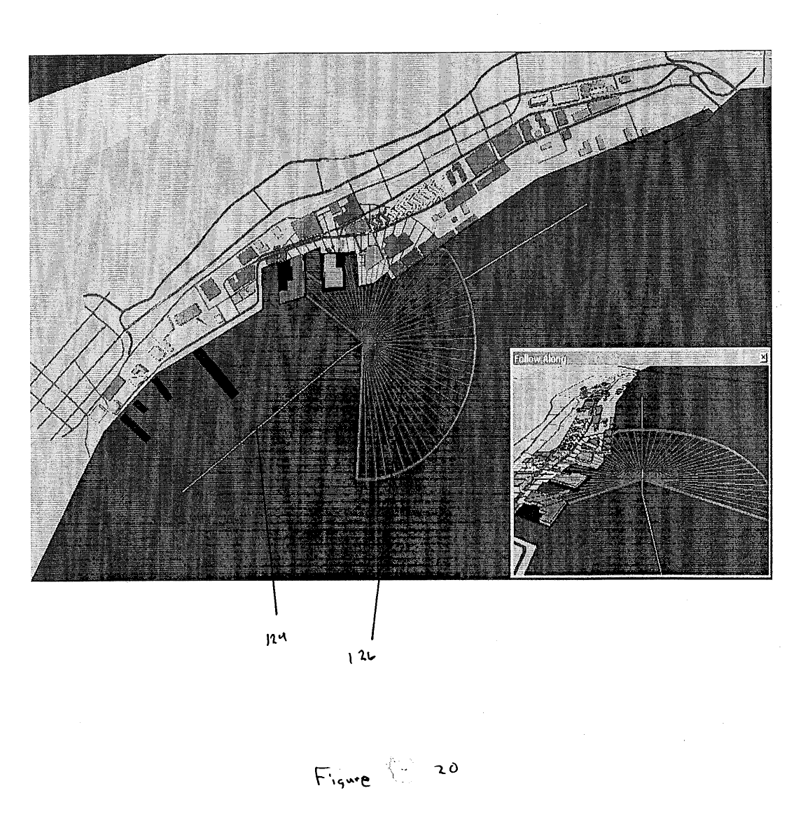

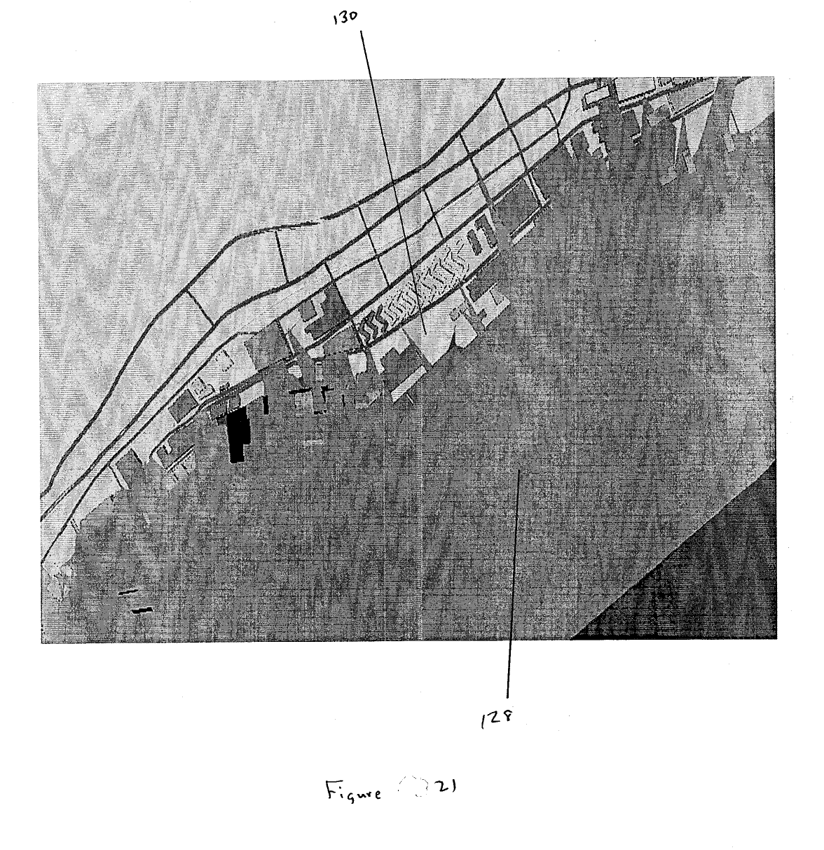

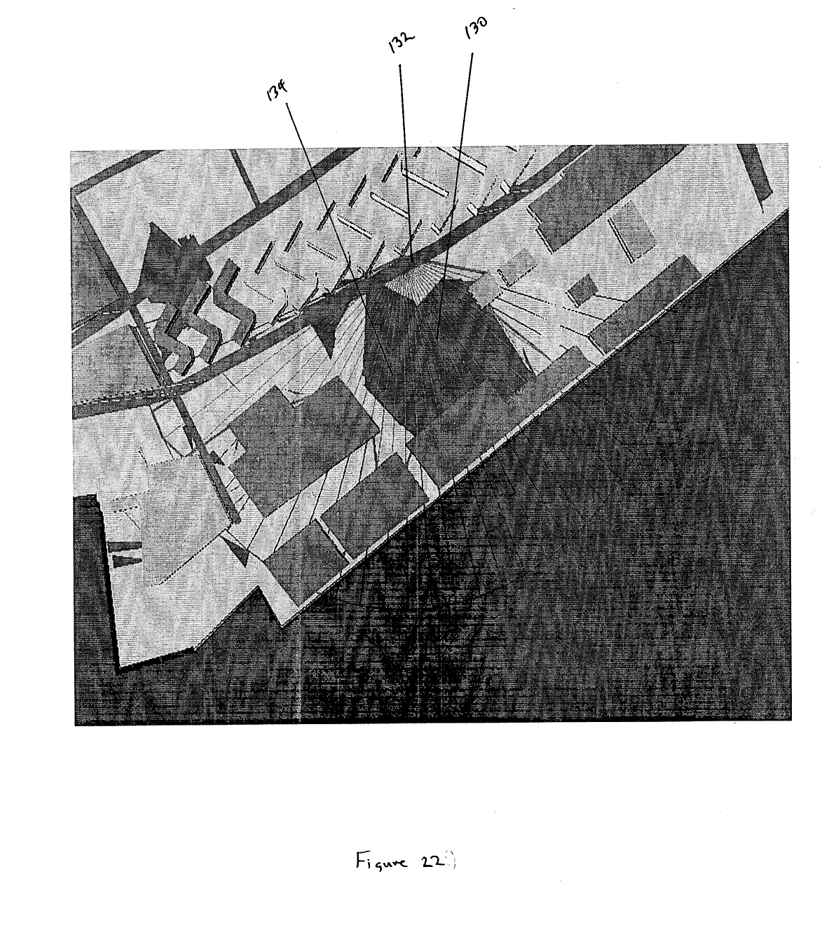

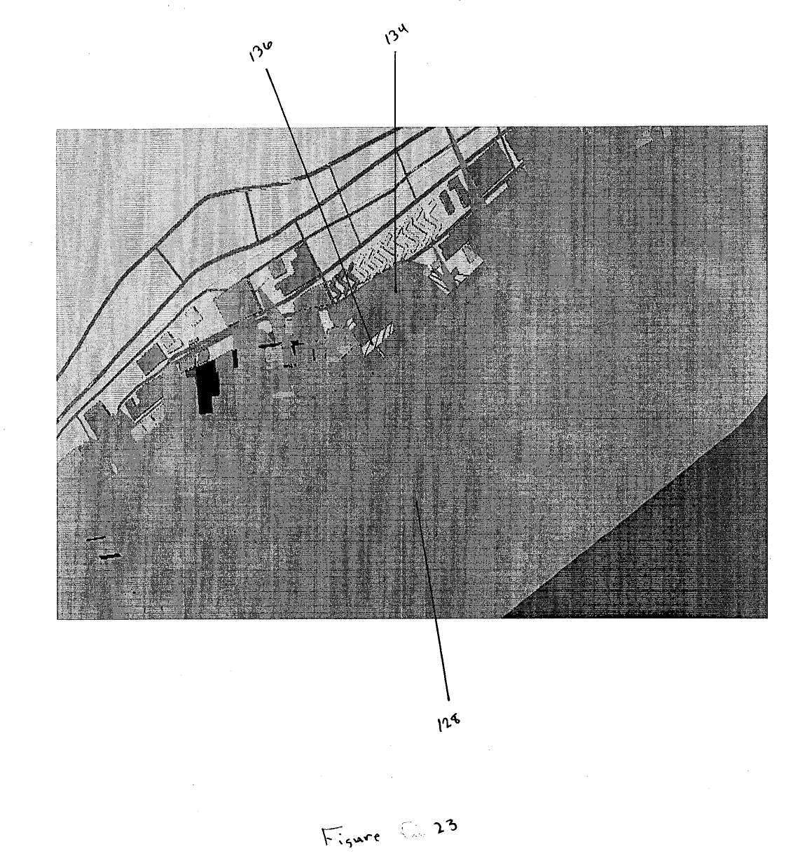

FIGS. 18-23 show an example of a security system analysis and design method for a harbor. FIG. 18 shows a surface depiction of a port facility that was created as described previously. In FIG. 19, a sentry patrol route 124 is added to indicate the presence of a vessel such as a Coast Guard patrol boat. In FIG. 20, an effective area 126 is created along each point of the patrol route. The effective area 126 is based on the line-of-sight calculations from the patrol boat. FIG. 21 shows a surveillance surface 128 showing all areas of observation that is created by overlaying all of the effective areas of the patrol boat along its patrol route. A blind spot 130 is identified because it is blocked from the view of the patrol boat by intervening structures. In FIG. 22, surveillance coverage is added for the blind spot 130 by placing a sensor adjacent to the area. An effective area 134 is calculated for the sensor in the same method as used for the patrol boat. In FIG. 23, the effective area 134 for the sensor is added to the surveillance surface 128 to provide an updated view of the security coverage. Blind spots 136 that are still not covered are identified. The process of adding or relocating security measures continues until the user is satisfied with the coverage that is provided by the integrated security system.

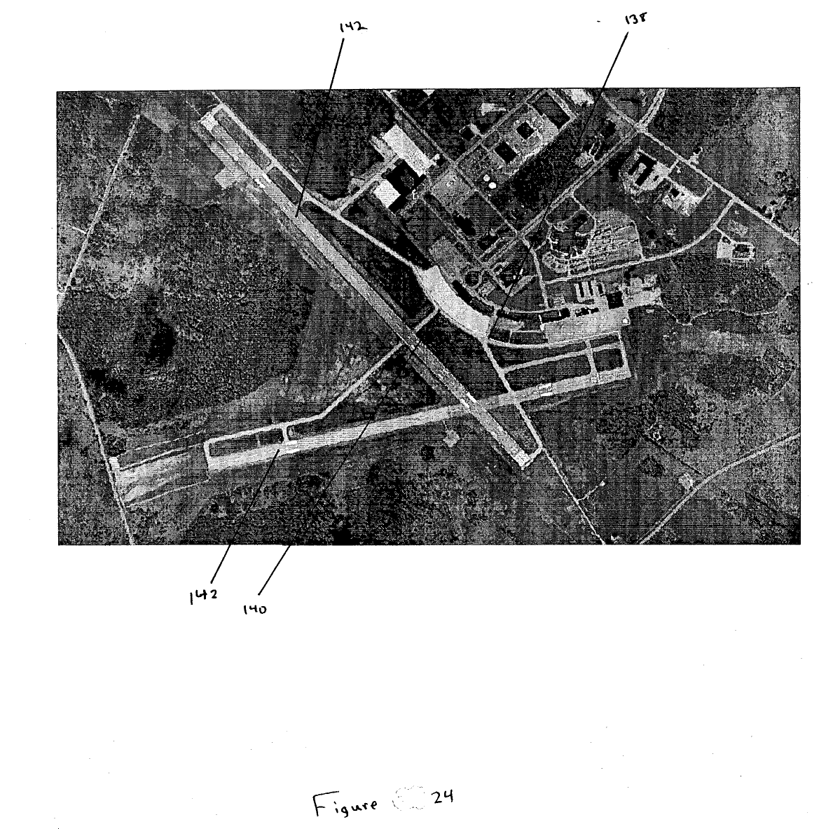

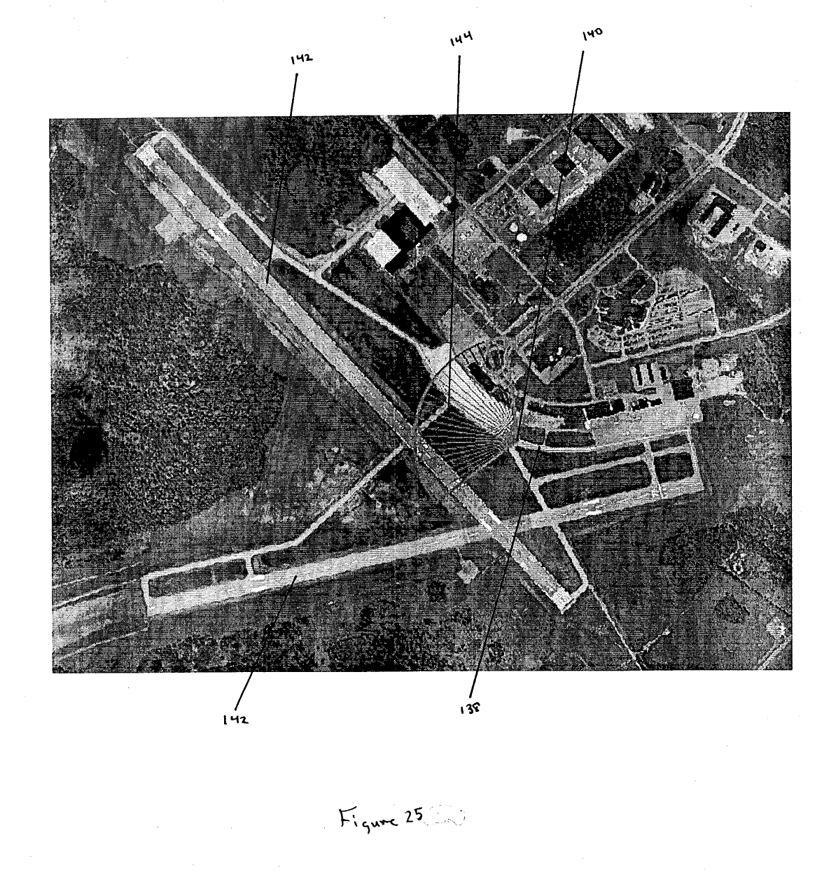

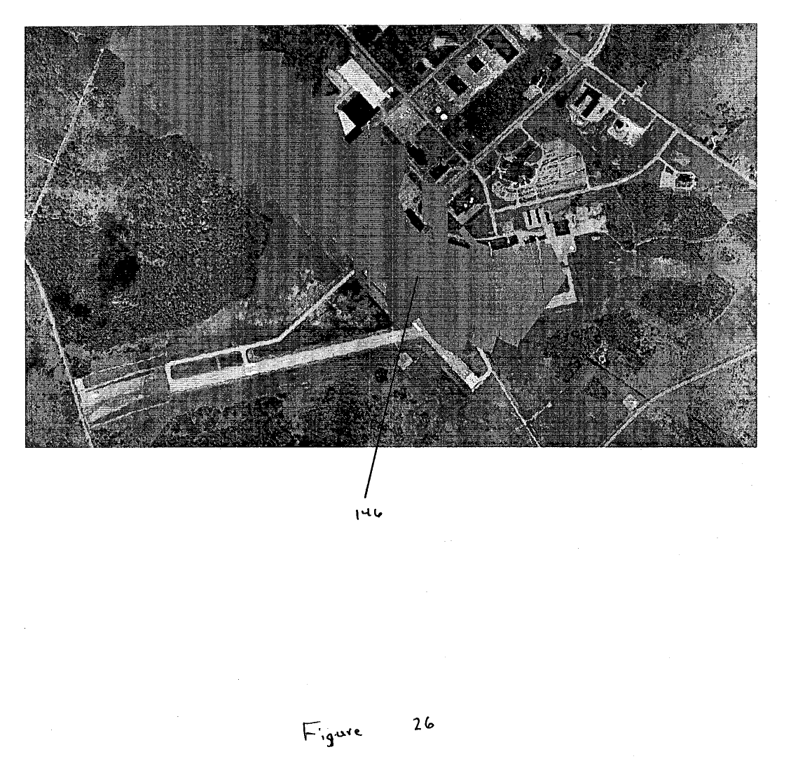

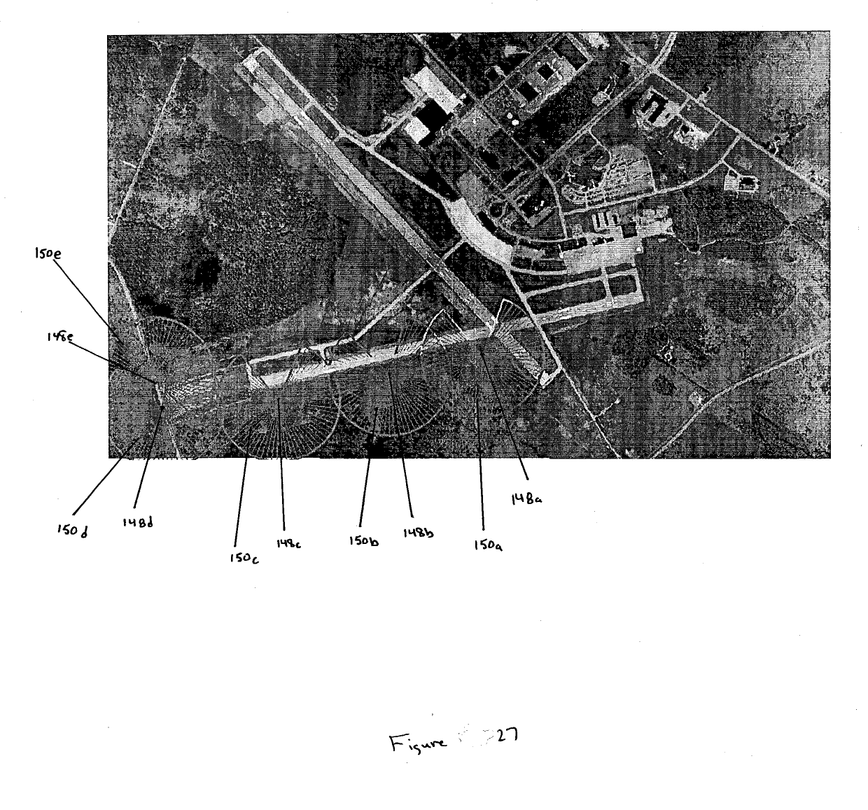

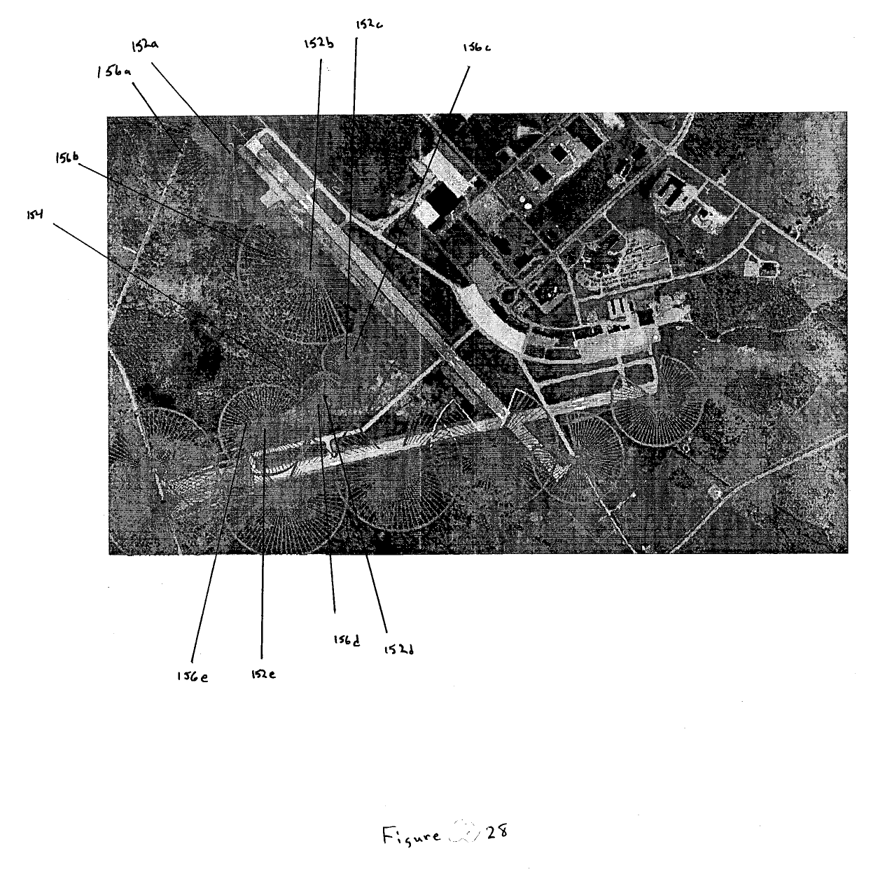

FIGS. 24-30 show another example of a security system analysis and design method for an airport. FIG. 24 shows a surface depiction of an airport and its surrounding facilities. A sentry patrol route 138 has been added to the surface depiction along a road 140 or “flight line” that runs between the runways 142 and the buildings of the area. FIG. 25 shows an effective area 144 being created from line-of-sight calculations along each point of the sentry patrol route 138. FIG. 26 shows a surveillance surface 146 that is created from all of the effective areas along the sentry patrol route. In FIG. 27, five separate sensors such as closed circuit television cameras with infrared capability (CCTV/IR) 148a-148e are placed along one runway. The effective areas are calculated for each sensor 150a-150e. The CCTV/IR sensors are placed so that their respective effective areas overlap. This ensures that there are no gaps in surveillance. In FIG. 28, five separate infrared sensors (IR) 152a-152e are placed along the perimeter of the wooded area 154 between the two runways. The respective effective areas 156a-156efor each sensor are then calculated.

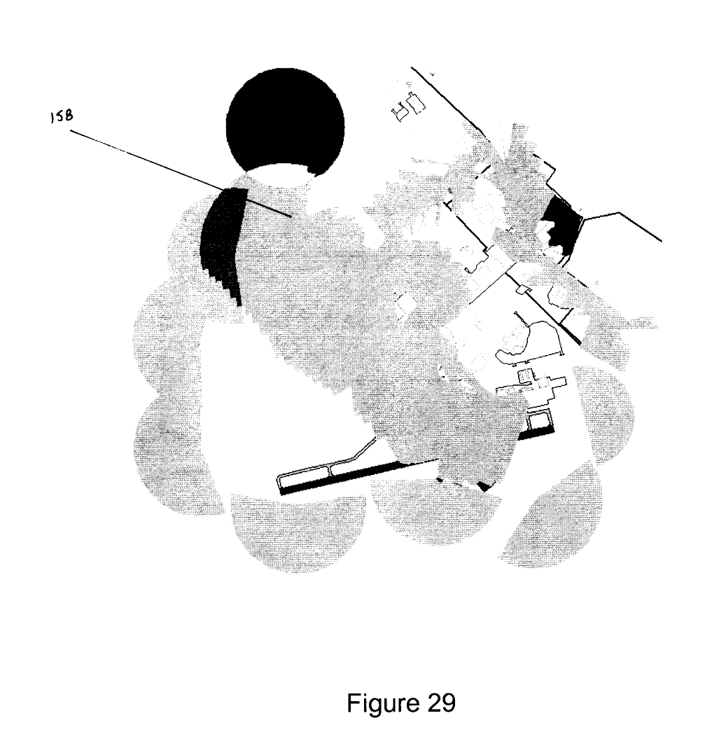

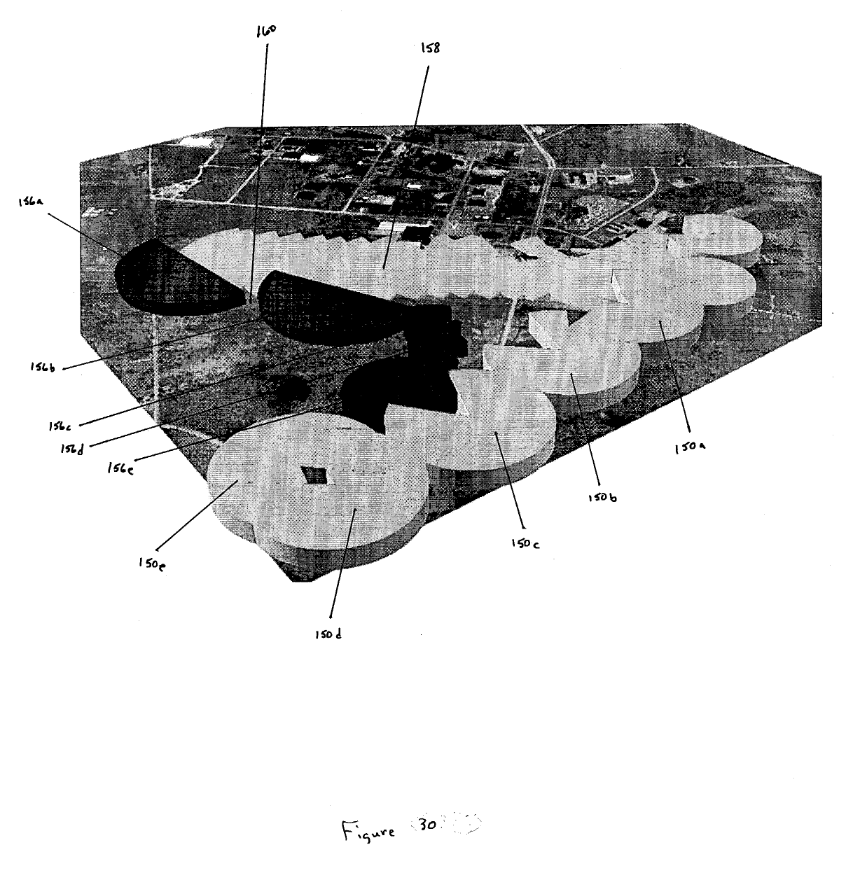

FIG. 29 shows a surveillance surface 158 that is created by combining the effective areas of each sensor and the sentry patrol. In FIG. 30, the surface 158 is shown with a three dimensional view of the effective areas. Also, the respective effective areas are sized based on their relative effectiveness. For example, the CCTV/IR arcs 150a-150e are slightly taller than the IR arcs 156a-156e. This indicates that a CCTV sensor with additional IR capabilities for night vision is more capable than a sensor with IR capabilities alone. Additionally, both the CCTV/IR arcs 150a-150e and the IR arcs 156a-156eare significantly taller than the effective area for the patrolling sentry 158. This indicates that the constant operation of both the CCTV/IR and the IR sensors are more effective than the intermittent presence of a mobile sentry.

Analysis of this example of a surveillance surface shows a small gap 160 in surveillance coverage between two IR sensors. The user may remedy this by adding another sensor or repositioning existing sensors to cover the gap 160. Another feature shown in this example is the color-coding of the various types of sensors. For example, the IR sensors are dark colored while the CCTV/IR sensors are lighter. This makes it easier for the user to determine the location and status of various surveillance measures.

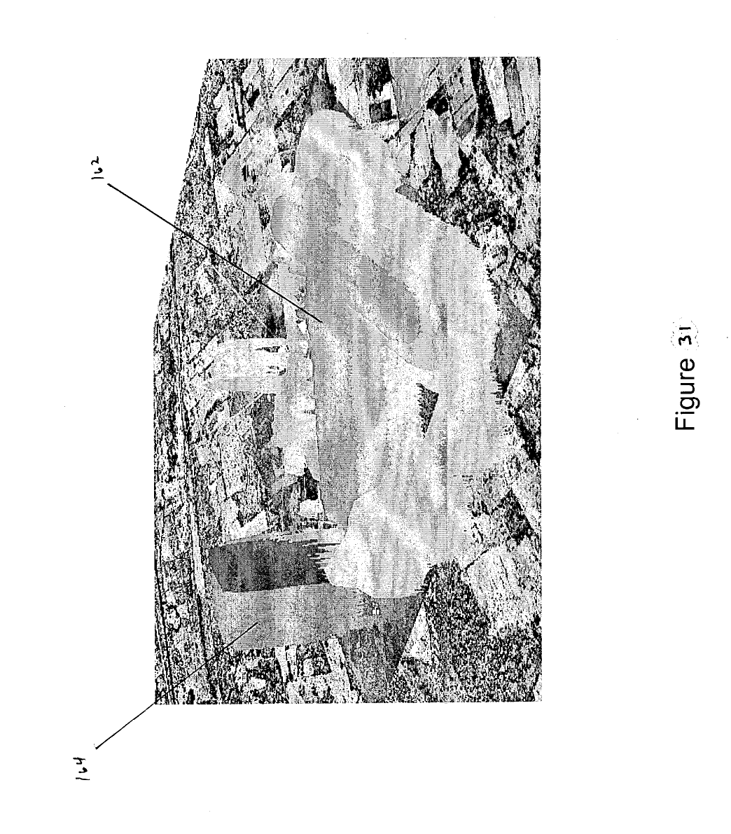

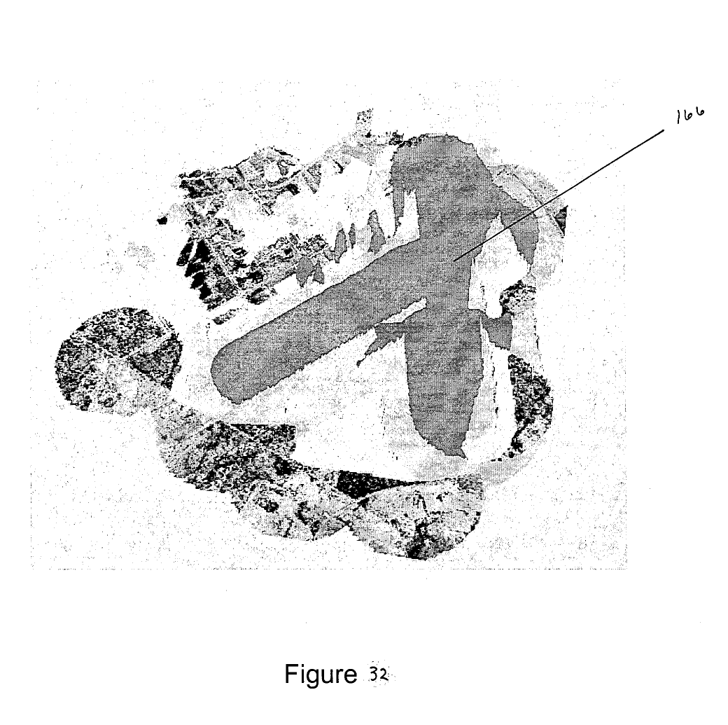

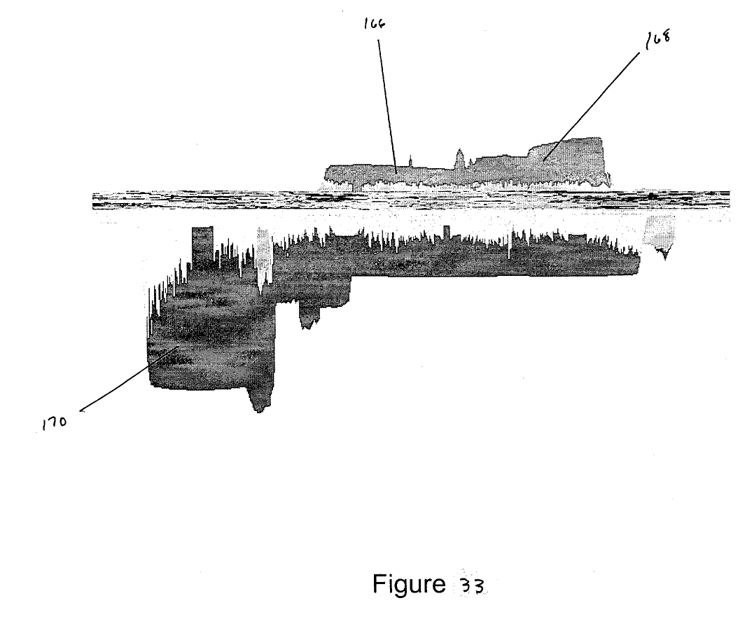

FIGS. 31-33 show another example of a security system analysis and design method for the airport shown previously in FIGS. 15-17 and 24-30. Specifically, FIG. 31 displays the risk surface 162 (from FIGS. 15-17) and surveillance surface 164 (from FIGS. 24-30) simultaneously. FIG. 32 displays the security surface 166 created by subtracting the surveillance surface 164 from the risk surface 162. FIG. 33 is a cross sectional view of the security surface 166 shown in FIG. 32. The areas of low risk/high surveillance 170 are shown at a lower relative height on the 3 dimensional depiction while the areas of high risk/low surveillance 168 are shown at a higher relative height. These depictions of relative risk/surveillance may also be color-coded (e.g., red for high risk, blue for low risk) to assist in the security analysis.

It is important to note that all or only some of the features, methods, and procedures described previously may be used together or separately to analyze a security system and/or design a security system if so desired. Many of the features are optional and may be used at the discretion of the user based on their needs. For example, a three dimensional version of a surveillance surface may not be necessary if only one type of surveillance measure is used. Consequently, the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. A method for analyzing a security system, comprising:
creating a surface depiction of a secured area covered by the security system;
placing existing security measures on the surface depiction; and
generating a surveillance surface on the surface depiction, where the surveillance surface shows the portion of the secured area that is under surveillance by the security measures.

2. The method of claim 1, further comprising:
generating a risk surface on the surface depiction, the risk surface showing buffer zones of the secured area; and
subtracting the surveillance surface from the risk surface on the surface depiction to display the portion of the risk surface that is not adequately protected by the security measures.

3. The method of claim 2, where the buffer zones are calculated based on a risk profile of the secured area.

4. The method of claim 2, where the buffer zones are calculated based on a kill envelope of a weapon.

5. The method of claim 1, where the surface depiction comprises:
a topographic depiction of the secured area;
a depiction of existing buildings and structures; and
a depiction of obstructions and points of interest within the secured area.

6. The method of claim 5, where the surface depiction further comprises:
environmental conditions for the secured area.

7. The method of claim 1, where the security measures comprise a sentry.

8. The method of claim 7, where the sentry is stationary.

9. The method of claim 8, where the sentry is mobile along a patrol route.

10. The method of claim 1, where the security measures comprise a sensor.

11. The method of claim 10, where the sensor is unmanned.

12. The method of claim 11, where the sensor is manned.

13. The method of claim 1, where the surveillance surface shows the effectiveness of a security measure relative to the effectiveness other security measures.

14. A method for analyzing a security system, comprising:
step for depicting a secured area covered by the security system;
step for depicting the security measures of the security system; and
step for showing the coverage of secured area by the security measures.

15. A method for designing a security system, comprising:
creating a surface depiction of an area to be secured;
placing a security measure on the surface depiction;
generating a surveillance surface on the surface depiction, where the surveillance surface shows the portion of the area that is under surveillance by the security measure; and
re-locating the security measure or placing additional security measures on the surface depiction to cover gaps in the surveillance surface.

16. The method of claim 15, further comprising:
generating a risk surface on the surface depiction, the risk surface showing buffer zones in the area; and
subtracting the surveillance surface from the risk surface on the surface depiction to display the portion of the risk surface that is not under surveillance by the security measures.

17. The method of claim 16, where the buffer zone is calculated based on a risk profile of the secured area.

18. The method of claim 16, where the buffer zone is calculated based on a kill envelope of a weapon.

19. The method of claim 15, where the surface depiction comprises:
a topographic depiction of the area;
a depiction of existing buildings and structures; and
a depiction of obstructions and points of interest within the area.

20. The method of claim 19, where the surface depiction further comprises:
environmental conditions for the secured area.

21. The method of claim 15, where the security measure comprises a sentry.

22. The method of claim 21, where the sentry is stationary.

23. The method of claim 21, where the sentry is mobile along a patrol route.

24. The method of claim 15, where the security measure comprises a sensor.

25. The method of claim 24, where the sensor is manned.

26. The method of claim 24, where the sensor is unmanned.

27. The method of claim 15, where the surveillance surface shows the effectiveness of a security measure relative to the effectiveness other security measures.

28. A method for designing a security system, comprising:
step for depicting an area to be secured by the security system;
step for depicting the placement of security measures of the security system;
step for showing surveillance coverage of the area to be secured by the security measures; and
step for depicting the adjustment or addition of security measures to cover gaps in surveillance coverage of the area to be secured.
